(19) United States
(12) Patent Application Publication
(10) Pub. No.: US 2009/0195550 A1
(43) Pub. Date: Aug. 6, 2009

(54) Display device and controlling method thereof

(75) Inventor: Jian-Feng Wang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/322,495

(22) Filed: Feb. 2, 2009

(30) Foreign Application Priority Data
Feb. 1, 2008 (TW) 97103997

(51) Int. Cl. G09G 5/10

(52) U.S. Cl. 345/589

(57) ABSTRACT

A system and method for controlling a display device includes a display panel, an on-screen display (OSD) system, and a gamma correction circuit. The OSD system includes an input system configured for adjusting a gamma value. The gamma correction circuit is configured for receiving a plurality of original grays, and outputting a plurality of correction grays according to the adjusted gamma value and the original grays to the display panel.

### FIELD OF THE DISCLOSURE

The present disclosure relates to a display device and a controlling method of the display device.

### GENERAL BACKGROUND

In general, a monitor is a display device that is used with an apparatus such as a computer in order to show data generated by the computer. Most popular monitors can be classified as either cathode ray tube (CRT) monitors or liquid crystal display (LCD) monitors.

Some of these monitors have an on-screen display (OSD) function to display information related to adjustment of display characteristics of video signals transmitted from the computer. An OSD menu activated on the screen of the monitor includes a plurality of sub menus for altering information associated with a brightness, a contrast, a shape, a color temperature, etc., of the monitor. However, gamma values of the monitors are usually not user selectable thus reducing viewing customization of a monitor.

Therefore, a new display device and a controlling method which can overcome the above-described shortcomings are desired.

### BRIEF DESCRIPTION OF THE DRAWINGS

FIG. 1 is a block diagram of a display device according to a first embodiment of the present invention.

FIG. 2 is a block diagram of a display device according to a second embodiment of the present invention.

### DETAILED DESCRIPTION OF EMBODIMENTS

Reference will now be made to the drawings to describe preferred and exemplary embodiments of the present invention in detail.

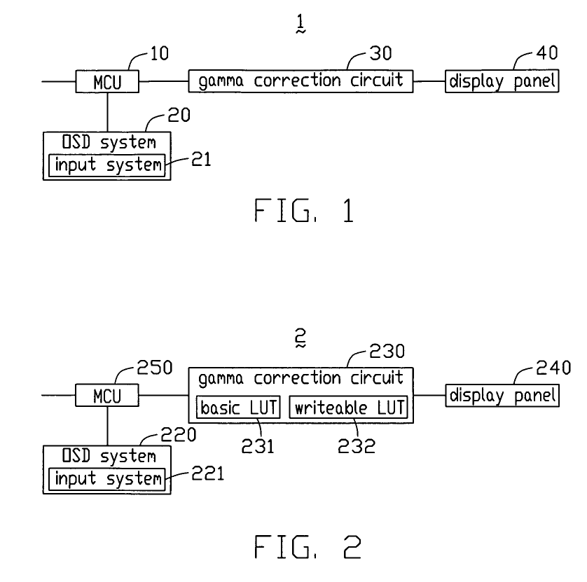

Referring to FIG. 1, a block diagram of a display device 1 according to a first embodiment of the present invention is shown. The display device 1 includes a microprocessor control unit (MCU) 10, an OSD system 20, a gamma correction circuit 30, and a display panel 40. The OSD system 20 is connected to the MCU 10. The MCU 10 is connected to the gamma correction circuit 30. The gamma correction circuit 30 is connected to the display panel 40.

The OSD system 20 can present an OSD menu (not shown) on the screen of the display panel 40. The OSD menu includes a gamma adjusting menu (not shown). The OSD system 20 includes an input system 21 configured for adjusting a gamma value of the display device 1. The OSD system 20 outputs a gamma adjusting signal to the gamma correction circuit 30 via the MCU 10 according to the adjusted gamma value.

The gamma correction circuit 30 includes a plurality of look-up tables (LUTs) (not shown). Each of the LUTs corresponds to one gamma value of the display device 1. The LUT is configured for storing a plurality of original grays of the display device 1 and a plurality of corresponding correction grays. The gamma correction circuit 30 is configured for activating the LUT that corresponds to the adjusted gamma value by control of the gamma adjusting signal. The MCU 10 is configured for receiving a plurality of external image signals and transforming the external image signals to the original grays. The external image signal can, for example, be a video graphics array (VGA) signal or a digital visual interface (DVI) signal. The gamma correction circuit 30 receives the original grays, determines a plurality of corresponding correction grays from the activated LUT, and outputs the correction grays to the display panel 40. The display panel 40 is configured for displaying images according to the correction grays.

Because the OSD system 20 of the display device 1 provides the gamma adjusting menu to adjust the gamma value, and the gamma correction circuit 30 can provide a plurality of correction grays to the display panel 40 according to the adjusted gamma value, users can adjust the gamma value of the display device 1 through the OSD system 20 allowing for customization of the display device 1.

An exemplary controlling method of the display device 1 includes the following steps.

Step one, the OSD system 20 presents an OSD menu on the screen of the display panel 40. The OSD menu includes a gamma adjusting menu.

Step two, a user adjusts a gamma value through the input system 21 of the OSD system 20. The OSD system 20 outputs a gamma adjusting signal to the gamma correction circuit 30 via the MCU 10 according to the adjusted gamma value.

Step three, the gamma correction circuit 30 activates the LUT that corresponds to the adjusted gamma value by control of the gamma adjusting signal.

Step four, the MCU 10 receives a plurality of external image signals, transforms the external image signals to the original grays, and outputs the original grays to the gamma correction circuit 30.

Step five, the gamma correction circuit 30 receives a plurality of original grays, determines a plurality of corresponding correction grays from the activated LUT according to the original grays, and outputs the correction grays to the display panel 40.

Step six, the display panel 40 displays images according to the correction grays.

Referring to FIG. 2, a block diagram of a display device 2 according to a second embodiment of the present invention is shown. The display device 2 is similar to the display device 1 except that a gamma correction circuit 230 only includes a basic LUT 231 and an extended LUT 232. The basic LUT 231 corresponds to a first gamma value of the display device 2. The basic LUT 231 stores a plurality of original grays and a plurality of first correction grays corresponding to the first gamma value and the original grays. The gamma correction circuit 230 calculates a plurality of second correction grays that corresponds to a second gamma value and the original grays according to the basic LUT 231, and writes the second correction grays into the extended LUT 232. It may be understood that the second gamma value is different from the first gamma value.

In one exemplary example, if the first gamma value is 2.2, the second correction grays can be expressed by the following formula:

$$Scale γ [ i ] = Scale 2.2 [ i ] + Scale 2.2 [ 256 ] \times ( {( \frac{i}{256} )}^{γ} - {( \frac{i}{256} )}^{2.2} )$$

The symbol i denotes an original gray. The symbol γ denotes the second gamma value. The symbol Scaleγ[i] denotes a second correction gray corresponding to the second gamma value and the original gray. The symbol Scale2.2[i] denotes a first correction gray corresponding to the first gamma value and the original gray. The symbol Scale2.2[256] denotes a first correction gray corresponding to the first gamma value and the original gray which is 256.

If an adjusted gamma value is the first gamma value, the gamma correction circuit 230 activates the basic LUT 231. If the adjusted gamma value is the second gamma value, the gamma correction circuit 230 calculates a plurality of second correction grays according to the basic LUT 231 and writes the second correction grays into the extended LUT 232. Then, the gamma correction circuit 230 activates the extended LUT 232.

Because the gamma correction circuit 230 only includes two LUTs 231, 232, the memory capacity of the LUTs 231, 232 is comparatively saved. Therefore, the cost of the gamma correction 230 is comparatively low.

An exemplary controlling method of the display device 2 includes the following steps.

Step one, the OSD system 220 presents an OSD menu on the screen of a display panel 240. The OSD menu includes a gamma adjusting menu.

Step two, a user adjusts a gamma value through an input system 221 of an OSD system 220. The OSD system 220 outputs a gamma adjusting signal to the gamma correction circuit 230 via the MCU 250 according to the adjusted gamma value.

Step three, if the adjusted gamma value is the first gamma value, the gamma correction circuit 230 activates the basic LUT 231 by control of the gamma adjusting signal. If the adjusted gamma value is second gamma value, the gamma correction circuit 230 calculates a plurality of second correction grays according to the basic LUT 231, writes the second correction grays into the extended LUT 232 by control of the gamma adjusting signal, and activates the extended LUT 232.

Step four, the MCU 250 receives a plurality of external image signals, transforms the external image signals to the original grays, and outputs the original grays to the gamma correction circuit 230. The external image signal can, for example, be VGA signal or DVI signal.

Step five, the gamma correction circuit 230 receives a plurality of original grays, determines a plurality of corresponding correction grays from the activated LUT according to the original grays, and outputs the correction grays to the display panel 240.

Step six, the display panel 240 displays images according to the correction grays.

In alternative embodiments, the OSD system 20, 220 can be directly connected to the gamma correction circuit 30, 230. Furthermore, the gamma correction circuit 30, 230 can be directly controlled by the gamma adjusting signal outputted from the OSD system 20, 220.

It is to be further understood that even though numerous characteristics and advantages of preferred and exemplary embodiments have been set out in the foregoing description, together with details of structures and functions associated with the embodiments, the disclosure is illustrative only, and changes may be made in detail (including in matters of arrangement of parts) within the principles of the disclosure to the full extent indicated by the broad general meaning of the terms in which the appended claims are expressed.

What is claimed is:

1. A display device, comprising:
a display panel;
an on-screen display (OSD) system comprising an input system configured for adjusting a gamma value of the display device; and
a gamma correction circuit configured for receiving a plurality of original grays of the display device, and outputting a plurality of correction grays according to the adjusted gamma value and the original grays to the display panel.

2. The display device of claim 1, wherein the gamma correction circuit comprises a plurality of look-up tables (LUTs) corresponding to gamma values of the display device respectively, each of the LUTs storing a plurality of original grays and a plurality of corresponding correction grays.

3. The display device of claim 2, wherein the OSD system outputs a gamma adjusting signal to the gamma correction circuit, wherein the gamma correction circuit activates a LUT corresponding to the adjusted gamma value by control of the gamma adjusting signal.

4. The display device of claim 3, wherein the OSD system presents an OSD menu on the screen of the display panel, the OSD menu comprising a gamma adjusting menu.

5. The display device of claim 1, further comprising a microprocessor control unit (MCU) configured for receiving a plurality of external image signals, transforming the external image signals to the original grays, and outputtingthe original grays to the gamma correction circuit, wherein the external image signal is a video graphics array (VGA) signal or a digital visual interface (DVI) signal.

6. The display device of claim 1, wherein the gamma correction circuit comprises a basic LUT and an extended LUT, the basic LUT corresponding to a first gamma value of the display device, the basic LUT storing a plurality of original grays and a plurality of first correction grays corresponding to the first gamma value and the original grays, and the gamma correction circuit configured for calculating a plurality of second correction grays that corresponds to a second gamma value of the display device and the original grays according to the basic LUT, and further configured for writing the second correction grays into the extended LUT, the second gamma value being different from the first gamma value.

7. The display device of claim 6, wherein the OSD system outputs a gamma adjusting signal to the gamma correction circuit, wherein the gamma correction circuit activates the basic LUT or the extended LUT according to the gamma adjusting signal.

8. The display device of claim 7, wherein if the adjusted gamma value is the first gamma value, the gamma correction circuit activates the basic LUT.

9. The display device of claim 8, wherein if the adjusted gamma value is second gamma value, the gamma correction circuit calculates a plurality of second correction grays according to the basic LUT and writes the second correction grays into the extended LUT by control of the gamma adjusting signal, the gamma correction circuit activates the extended LUT.

10. The display device of claim 9, wherein the first gamma value is 2.2.

11. The display device of claim 10, wherein the second correction grays is expressed by the following formula:
$$Scale γ [ i ] = Scale 2.2 [ i ] + Scale 2.2 [ 256 ] \times ( {( \frac{i}{256} )}^{γ} - {( \frac{i}{256} )}^{2.2} ) ,$$
wherein, the symbol i denotes an original gray, the symbol γdenotes the second gamma value, the symbol Scaleγγ[i] denotes a second correction gray corresponding to the second gamma value and the original gray, the symbol Scale2.2[i] denotes a first correction gray corresponding to the first gamma value and the original gray, the symbol Scale2.2[256] denotes a first correction gray corresponding to the first gamma value and the original gray which is 256.

12. The display device of claim 11, wherein the OSD system presents an OSD menu on the screen of the display panel, the OSD menu includes a gamma adjusting menu.

13. A method for controlling gamma values of a display device, the display device comprising a display panel, an on-screen display (OSD) system comprising an input system configured for adjusting a gamma value of the display device, and a gamma correction circuit, the method comprising:
adjusting a gamma value through the input system of the OSD system;
receiving original grays of the display device using the gamma correction circuit; and
outputting a plurality of correction grays according to the adjusted gamma value and the original grays to the display panel using the gamma correction circuit.

14. The method of claim 13, wherein the gamma correction circuit comprises a plurality of look-up tables (LUTs) corresponding to gamma values of the display device, each of the LUTs storing a plurality of original grays and a plurality of corresponding correction grays of the display device.

15. The method of claim 14, further comprising the following steps positioned between adjusting a gamma value and receiving the original grays:
in response to the gamma value being adjusted, outputting a gamma adjusting signal to the gamma correction circuit using the OSD system; and
activating a LUT corresponding to the adjusted gamma value using the gamma correction circuit according to the gamma adjusting signal.

16. The method of claim 15, further comprising the following steps positioned between receiving the original grays and outputting the correction grays:
determining a plurality of corresponding correction grays from the activated LUT according to the original grays using the gamma correction circuit.

17. The method of claim 16, wherein the display device further comprises a microprocessor control unit (MCU), the method further comprising a step positioned between activating the LUT and receiving the original grays:
receiving a plurality of external image signals using the MCU, transforming the external image signals to the original grays, and outputting the original grays to the gamma correction circuit.

18. The method of claim 13, wherein the gamma correction circuit further comprises a basic LUT and an extended LUT, the basic LUT corresponding to a first gamma value of the display device, the basic LUT storing a plurality of original grays, a plurality of first correction grays corresponding to the first gamma value and the original grays, and the method further comprising a step positioned between adjusting a gamma value and receiving the original grays:
outputting a gamma adjusting signal to the gamma correction circuit using the OSD system according to the adjusted gamma value;
if the adjusted gamma value is the first gamma value, activating the basic LUT using the gamma correction circuit by control of the gamma adjusting signal, if the adjusted gamma value is different from the first gamma value, calculating a plurality of second correction grays using the gamma correction circuit according to the basic LUT, writing the second correction grays into the extended LUT by control of the gamma adjusting signal, and activating the extended LUT.

19. The method of claim 18, further comprising the following step positioned between receiving the original grays and outputting the correction grays:
determining a plurality of corresponding correction grays from the activated LUT using the gamma correction circuit according to the original grays.

20. The method of claim 19, wherein the first gamma value is 2.2, and the second correction grays is expressed by the following formula:
$$Scale γ [ i ] = Scale 2.2 [ i ] + Scale 2.2 [ 256 ] \times ( {( \frac{i}{256} )}^{γ} - {( \frac{i}{256} )}^{2.2} ) ,$$
wherein, the symbol i denotes an original gray, the symbol γ denotes the second gamma value, the symbol Scaleγ[i] denotes a second correction gray corresponding to the second gamma value and the original gray, the symbol Scale2.2[i] denotes a first correction gray corresponding to the first gamma value and the original gray, the symbol Scale2.2[256] denotes a first correction gray corresponding to the first gamma value and the original gray which is 256.
